(19) United States
(12) Patent Application Publication
(10) Pub. No.: US 2019/0068857 A1
(43) Pub. Date: Feb. 28, 2019

(54) EXTENDED FIELD-OF-VIEW ILLUMINATION SYSTEM

(71) Applicant: QUALCOMM Incorporated, San Diego, CA (US)

(72) Inventor: Russell GRUHLKE, San Jose, CA (US)

(21) Appl. No.: 16/116,774

(22) Filed: Aug. 29, 2018

Related U.S. Application Data
(60) Provisional application No. 62/551,741, filed on Aug. 29, 2017.

(51) Int. Cl. H04N 5/225; H04N 5/235; H04N 5/232

(52) U.S. Cl. CPC H04N 5/2256; H04N 5/23296; H04N 5/2259; H04N 5/2354

(57) ABSTRACT

Extended field-of-view illumination and image capture is disclosed. An apparatus comprises a first light source oriented along a first illumination axis, a second light source oriented along a second illumination axis, a first image sensor oriented along a first optical axis, a second image sensor oriented along a second optical axis, and a common cover substrate. The first illumination axis may be directed away from the second optical axis, and the second image sensor may be closer to the first light source than the first image sensor. The second illumination axis may be directed away from the first optical axis, and the first image sensor may be closer to the second light source than the second image sensor.

### CROSS-REFERENCE TO RELATED APPLICATIONS

This application claims the benefit of U.S. Provisional Application No. 62/551,741, filed Aug. 29, 2017, entitled “Extended Field-Of-View Illumination System” which is incorporated herein by reference in its entirety.

### BACKGROUND

Aspects of the disclosure relate to extended field-of-view illumination systems. In certain applications, an “always on” vision sensor system is characterized by low power operation, adequate performance, and low cost. For night time or low ambient lighting conditions, artificial illumination may be required. This can be done by placing light-emitting diodes (LEDs), e.g., infrared LEDs, adjacent to the camera. For instance, in a particular application, a large field-of-view (FOV) may be desired (e.g., >150 degrees—total field of view along at least one axis). A typical one-piece lens system may not meet the adequate performance criteria for this large a FOV. A two-piece lens system can possibly meet the adequate performance criteria but potentially not the low cost criteria. FIG. 1A illustrates the limited image capture angle of a camera having a one-piece lens system. As shown, the image capture angle of the camera is +/−45 degrees (90 degrees total). This is insufficient to cover, for example capture an image for, a wide field of view, e.g., 150 degrees. FIG. 1B illustrates the limited light spread angle of a light source, in this case a LED light source. As shown, the light spread angle of the LED light source is +/−60 degrees (120 degrees total). This is also insufficient to cover, for example illuminate, a wide field of view, e.g., 150 degrees.

### SUMMARY

Apparatuses, methods, systems, and non-transitory computer-readable media are described relating to extended field-of-view illumination and image capture of a scene. In at least one embodiment, an apparatus comprises a first light source oriented along a first illumination axis, a second light source oriented along a second illumination axis, a first image sensor oriented along a first optical axis, and a second image sensor oriented along a second optical axis. The first light source, second light source, first image sensor, and second image sensor may be separated from the scene by a common cover substrate. The first light source may be configured to illuminate a first portion of the scene, by emitting light through the common cover substrate. The second light source may be configured to illuminate a second portion of the scene, by emitting light through the common cover substrate. The first image sensor may be configured to obtain an image of the first portion of the scene, as illuminated by the first light source, by capturing light through the common cover substrate. The second image sensor may be configured to obtain an image of the second portion of the scene, as illuminated by the second light source, by capturing light through the common cover substrate. The first illumination axis of the first light source may be directed away from the second optical axis of the second image sensor, and the second image sensor may be closer to the first light source than the first image sensor. The second illumination axis of the second light source may be directed away from the first optical axis of the first image sensor, and the first image sensor may be closer to the second light source than the second image sensor.

The first optical axis may be substantially parallel to the first illumination axis, and the second optical axis may be substantially parallel to the second illumination axis. In one embodiment, the first and second optical axes cross each other in a direction towards the scene, and the first and second illumination axes diverge from each other in a direction towards the scene. In another embodiment, the first and second optical axes diverge from each other in a direction towards the scene, and the first and second illumination axes cross each other in a direction towards the scene.

Optionally, at least one opaque baffle separates one or both of the first or second light sources from one or both of the first or second image sensors. In one embodiment, the common cover substrate has a flat shape. In another embodiment, the common cover substrate has a curved shape. In one embodiment, the common cover substrate comprises a glass material. In another embodiment, the common cover substrate comprises a synthetic material.

In at least one embodiment, a method for extended field-of-view illumination and image capture of a scene is presented. The method may involve emitting light through a common cover substrate along a first illumination axis to illuminate a first portion of the scene by a first light source, as well as emitting light through the common cover substrate along a second illumination axis to illuminate a second portion of the scene by a second light source. The method may further involve capturing light through the common cover substrate along a first optical axis to obtain an image of the first portion of the scene, as illuminated by the first light source, using a first image sensor. In addition, the method may involve capturing light through the common cover substrate along a second optical axis to obtain an image of the second portion of the scene, as illuminated by the second light source, using a second image sensor, the second image sensor being disposed closer to the first light source than the first image sensor and the first image sensor being disposed closer to the second light source than the second image sensor. The first illumination axis of the first light source may be directed away from the second optical axis of the second image sensor. The second illumination axis of the second light source may be directed away from the first optical axis of the first image sensor.

In at least one embodiment, a system for extended field-of-view illumination and image capture of a scene is presented. The system may comprise means for emitting light through a common cover substrate along a first illumination axis to illuminate a first portion of the scene by a first light source, as well as means for emitting light through the common cover substrate along a second illumination axis to illuminate a second portion of the scene by a second light source. The system may comprise means for capturing light through the common cover substrate along a first optical axis to obtain an image of the first portion of the scene, as illuminated by the first light source, using a first image sensor. In addition, the system may comprise means for capturing light through the common cover substrate along a second optical axis to obtain an image of the second portion of the scene, as illuminated by the second light source, using a second image sensor, the second image sensor being disposed closer to the first light source than the first image sensor and the first image sensor being disposed closer to the second light source than the second image sensor. The first illumination axis of the first light source may be directed away from the second optical axis of the second image sensor. The second illumination axis of the second light source may be directed away from the first optical axis of the first image sensor.

In at least one embodiment, a non-transitory computer-readable medium having instructions embedded thereon for providing extended field-of-view illumination is presented. The instructions, when executed by one or more processing units controlling an apparatus comprising a common cover substrate, a first light source having a first illumination axis, a second light source having a second illumination axis, a first image sensor having a first optical axis directed away from the second illumination axis, and a second image sensor having a second optical axis directed away from the first illumination axis, wherein the second image sensor is disposed closer to the first light source than the first image sensor and the first image sensor is disposed closer to the second light source than the second image sensor, may cause the one or more processing units (1) operate the first light source to illuminate a first portion of a scene by emitting light through the common cover substrate along the first illumination axis, (2) operate the second light source to illuminate a second portion of the scene by emitting light through the common cover substrate along the second illumination axis, (3) operate the first image sensor oriented along the first optical axis to capture light through the common cover substrate to obtain an image of the first portion of the scene, and (4) operate the second image sensor oriented along the second optical axis to capture light through the common cover substrate to obtain an image of the second portion of the scene.

### BRIEF DESCRIPTION OF THE DRAWINGS

Illustrative embodiments are described in detail below with reference to the following figures:

FIG. 1A illustrates the limited image capture angle of a camera having a one piece lens system;

FIG. 1B illustrates the limited light spread angle of a light source, e.g., a light emitting diode (LED) light;

FIG. 2A illustrates two cameras placed at different angles to give a total field of view greater than that of a single camera, according to an embodiment of the disclosure;

FIG. 2B shows an example of the overlapping images that may be captured by two cameras;

FIG. 2C is a plot of the light flux density as a function of the horizontal angle in the combined image captured by the two cameras discussed with respect to FIG. 2B;

FIG. 3 illustrates the potential problem of light reflected off of a common cover substrate, which can negatively impact the performance of an expanded field-of-view illumination and image capture system;

FIG. 4 illustrates the placement of two LEDs at angles causing a fill of the combined camera FOV, with two cameras placed in a “cross view” arrangement, according to an embodiment of the disclosure;

FIG. 5 illustrates the placement of two LEDs at angles causing a fill of the combined camera FOV, with two cameras placed in a “divergent view” arrangement;

FIG. 6 is a system diagram of an illustrative system employing the extended field-of-view illumination and imaging techniques of the present disclosure; and

FIG. 7 is a flow chart presenting an example of a process for extended field-of-view illumination and image capture of a scene.

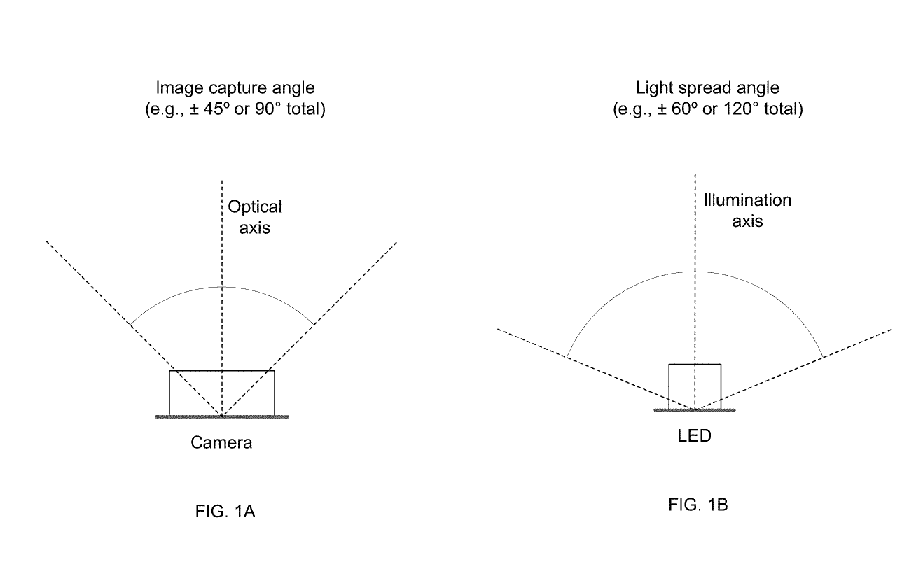

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

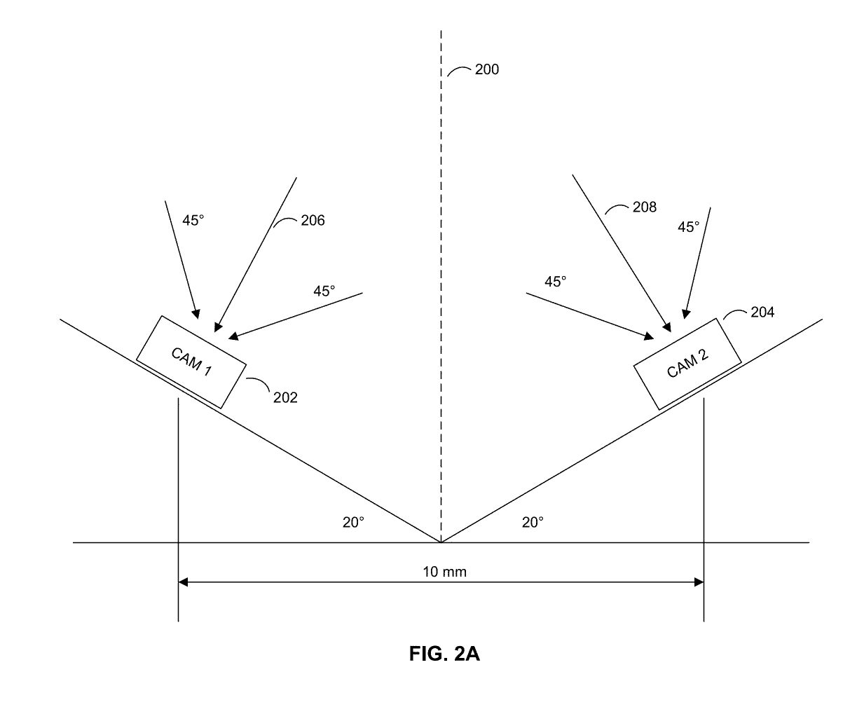

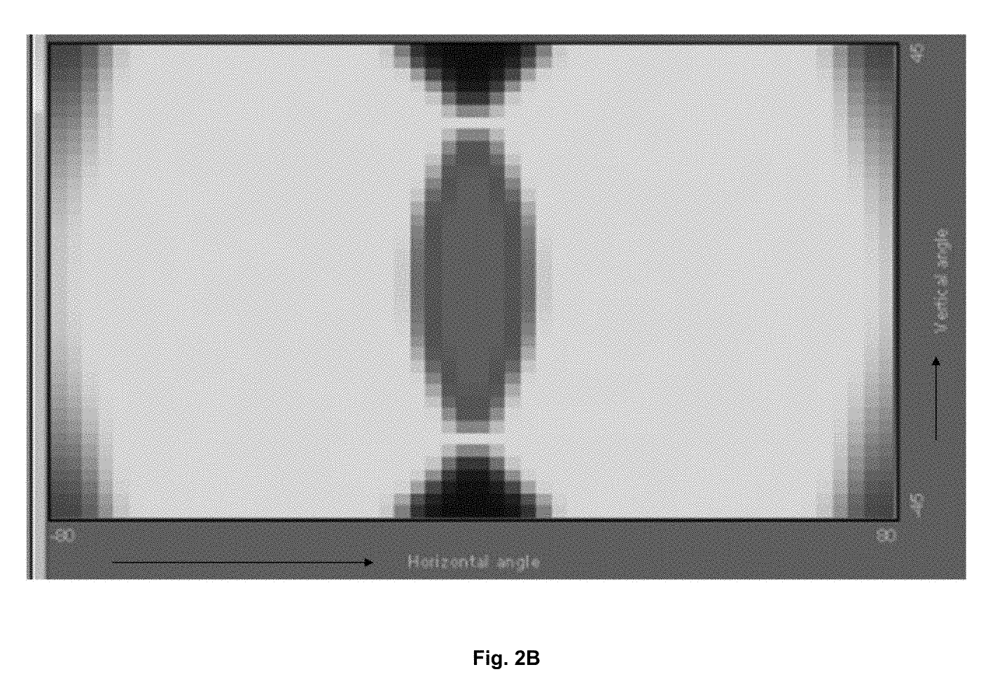

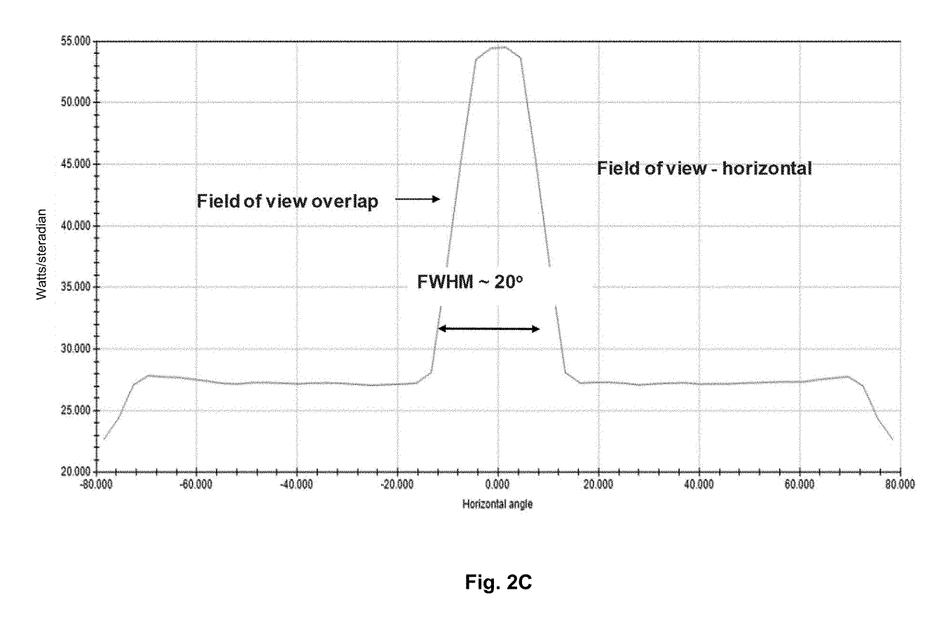

According to various embodiments, a solution to the dilemma of achieving a wider FOV while keeping costs reasonable involves using multiple image sensors. For example, two single-piece lens systems may be placed at different angles giving a total FOV spanning more than 150 degrees along one axis. FIGS. 2A, 2B, and 2C illustrate the angular view from both cameras and the basic camera geometry. According to one embodiment, this camera configuration is contained under a transparent cover glass. While embodiments below refer to “cameras,” different types of image sensors may be utilized. These include image sensors that capture different light frequencies including visible, infrared (IR), ultraviolet (UV), and/or other types of light.

In particular, FIG. 2A illustrates two cameras placed at different angles to give a total field of view greater than that of a single camera, according to an embodiment of the disclosure. Here, a central axis 200 defines a direction toward the scene to be captured. A first camera 202 is placed to one side of the central axis, at an angle of 20 degrees toward the central axis. A second camera 204 is placed on the other side of the central axis, also at an angle of 20 degrees toward the central axis. The first camera 202 has a first optical axis 206 and a FOV extending 45 degrees from the first optical axis 206. The second camera has a second optical axis 208 and a FOV extending 45 degrees from the second optical axis 208. The FOV of the first camera 202 and the FOV of the second camera 204 intersect one another to form a larger, combined FOV that spans more than 150 degrees around the central axis 200. In this figure, the first camera 202 and the second camera 204 are separated by a distance of 10 mm. The particular angles and distances described in this figure are for illustrative purposes, and other values may be used.

FIG. 2B shows an example of the overlapping images that may be captured by cameras 202 and 204, according to an embodiment of the disclosure. The x-axis represents the horizontal angle, and the y-axis represents the vertical angle. As discussed previously, cameras 202 and 204 each has an individual FOV of +/−45 degrees or 90 degrees (total). The two images taken by cameras 202 and 204, respectively, may be stitched together to form a combined image. Here, the combined FOV in the horizontal direction is greater than 150 degrees. The area of overlap between the two images spans about 20 degrees. The FOV of the combined image in the vertical direction is 90 degrees.

FIG. 2C is a plot of the light flux density as a function of the horizontal angle in the combined image captured by cameras 202 and 204, according to an embodiment of the disclosure. The y axis represents light flux density, measured in units of flux per steradian. The x axis represents the horizontal angle, measured in degrees. As shown in the figure, the light flux density may double in the area of overlap. In this example, outside the area of overlapping FOV, the light flux density is roughly 27 Watts/steradian. Inside the area of overlapping FOV, the light flux density is roughly 54 Watts/steradian. The full width at half maximum (FWHM), which measures the width of the plot at half of the maximum value, is about 20 degrees. This corresponds to the area of overlap of the FOVs of the two cameras being about 20 degrees.

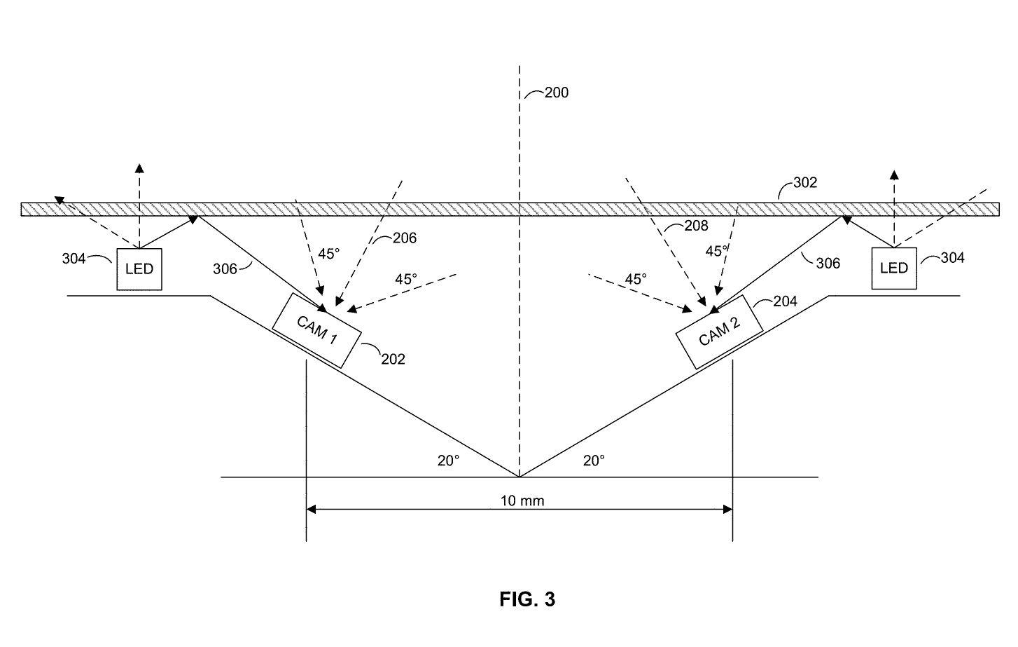

FIG. 3 illustrates the potential problem of light reflected off of a common cover substrate, which can negatively impact the performance of an expanded field-of-view illumination and image capture system. Here, the first camera 202 and second camera 204 are arranged at different angles to achieve an expanded, combined FOV in a manner similar to that discussed in FIG. 2A. A common cover substrate 302 may be used to cover components such as both the first camera 202 and the second camera 204, and hence is common to both cameras. While a common cover glass is described in certain specific embodiments, it is understood that a common cover glass includes a common cover substrate 302 serving as a common cover glass. The common cover substrate 302 may be made of a glass material, a synthetic material such as a plastic, etc. The common cover substrate can have a flat shape, e.g., a flat plane of glass, or a curved shape, e.g., a domed glass cover. The common cover substrate 302 may be used to protect components such as cameras, lenses, light sources, etc., from abrasion, contamination, etc. associated with the environment.

To provide illumination for capturing an image of the scene, an illumination system may be employed in conjunction with image sensors such as the first camera 202 and the second camera 204. However, the illumination system having the camera geometry shown in FIG. 2A and FIG. 3, as well as other camera geometries, may be problematic for at least two reasons. First, standard LEDs may emit light, for example, into +/−60 degrees or 120 degrees (total) and, thus, are not adequate to cover the desired 150 degrees or more of the camera's FOV. Also, a custom designed LED with lens system that would solve this issue is not necessarily cost effective. Secondly, a small format constraint may be specified, which could mean that an LED be placed in close proximity to the camera. Light emitted at large angles can reflect or scatter off the cover glass back into the camera, which can reduce the optical performance of the camera system.

An example of light reflected off of a common cover substrate is shown in FIG. 3. LEDs 304 are positioned to provide illumination for the scene during image capture by cameras 202 and 204. The spread of light from each of the LEDs 304 may be +/−60 degrees, for instance. Light emanating from LEDS 304 may reflect off of the common cover substrate 302 to produce reflected light 306, which can reach the first camera 202 and the second camera 204. Depending on relative angles of the various components and the resulting geometry, the reflected light 306 may or may not arrive at the first camera 202 and the second camera 204 at an angle that is within the FOV (e.g., +/−45 degrees) of each camera. If the reflected light 306 arrives at an angle within the FOV of the camera, this clearly presents an issue, because the image captured would include an image of the LED, thus directly degrading the quality of the image. However, even if the reflected light 306 arrives at an angle outside of the FOV of the camera, image quality can still be negatively impacted. Once the reflected light 306 reaches the camera, components such as lens, bezels, etc. can scatter, reflect, and/or bend reflected light 306 in various ways, such that the resulting scattered, reflected, and/or bent light can reach sensors within cameras 202 and 204, thus degrading the quality of the captured images.

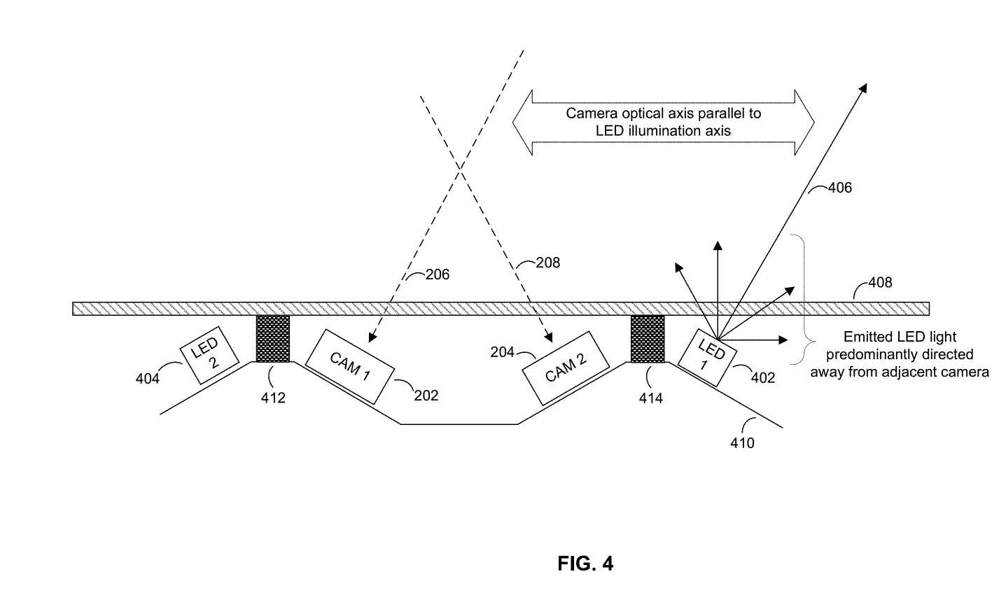

FIG. 4 illustrates the placement of two LEDs at angles causing a fill of the combined camera FOV, with two cameras placed in a “cross view” arrangement, according to an embodiment of the disclosure. As shown the figure, a first camera 202 and a second camera 204 are positioned at different angles to achieve a wider combined FOV. The first camera 202 captures a first portion of the scene, and the second camera 204 captures a second portion of the scene. As shown, the optical axis 206 of the first camera 202 and the optical axis 208 of the second camera 204 cross each other in a direction towards (e.g., en route to) the scene.

A first LED 402 and a second LED 404 are positioned to illuminate the scene while emitting light away from both cameras. Here, the first LED 402 illuminates the first portion of the scene, while an image of the first portion of the scene is captured by the first camera 202. The arrangement avoids or reduces an amount of light emitted from the first LED 402 and reflected back from the common cover glass 408 being directly or indirectly captured by the second camera 204, which is adjacent to the first LED 402. This is due to the illumination axis 406 of the first LED 402 being directed away from the second camera 204. The avoidance or reduction of such reflected light is achieved even though the second camera 204 is located in close proximity to the first LED 402. In this embodiment, the illumination axis 406 of the first LED 402 is substantially parallel to the optical axis 206 of the first camera 202.

A similar arrangement is provided with respect to the second camera 204 and the second LED 404. The second LED 404 illuminates the second portion of the scene, while an image of the second portion of the scene is captured by the second camera 204. The arrangement avoids or reduces an amount of light emitted from the second LED 404 and reflected back from the common cover glass 408 being directly or indirectly captured by the first camera 202, which is adjacent to the second LED 404. This is due to the illumination axis (not shown) of the second LED 404 being directed away from the first camera 202. The avoidance or reduction of such reflected light is achieved even though the first camera 202 is located in close proximity to the second LED 404. In this embodiment, the illumination axis (not shown) of the second LED 404 is substantially parallel to the optical axis 208 of the second camera 204.

In the embodiment shown in FIG. 4, the illumination axis of each of the two LEDs 402 and 404 is aligned with the optical axis of one of the cameras. This fills the FOV (in the far field) of each camera with light as long as the angular emission of each LED is greater than the FOV of the respective camera. Also, each LED is orientated to emit light predominantly away from the adjacent camera, which greatly reduces the possibility of light contamination occurring when LED light reflects/scatters off the cover glass directly into the camera.

According to an embodiment, a support structure 410 may be used for mounting the two cameras 202 and 204 and two LEDs 402 and 404 at the desired locations and in the desired orientations behind the cover glass 408. The support structure 410 may also be used to secure the cover glass 408. Furthermore, the support structure may be used to mount one or more optional opaque baffles 412 and 414, which are described in later sections.

As discussed in various embodiments, the illumination axis of an LED may be substantially parallel with the optical axis of a camera. As described herein, the term “substantially parallel” refers to axes having similar orientations but do not require two axes to be exactly parallel.

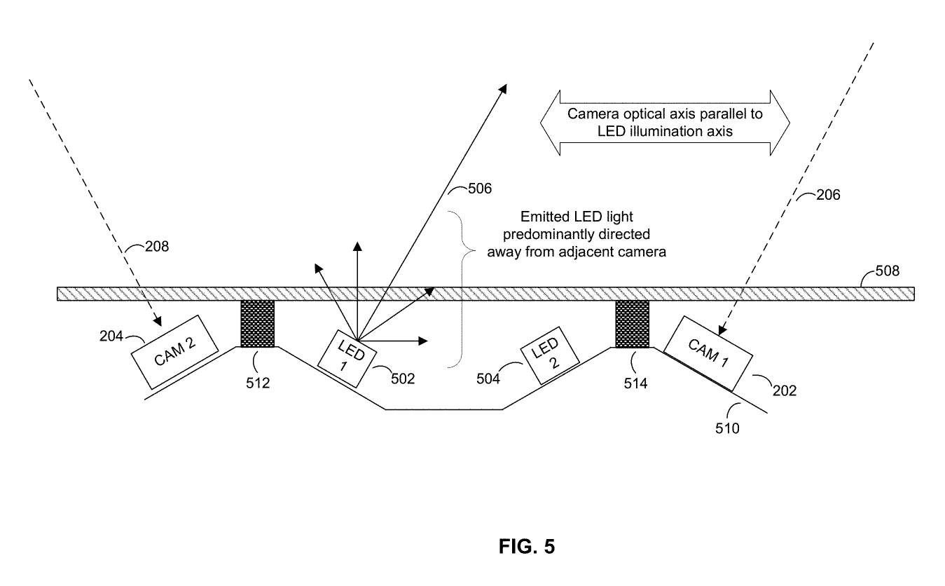

FIG. 5 illustrates the placement of two LEDs at angles causing a fill of the combined camera FOV, with two cameras placed in a “divergent view” arrangement, according to an embodiment of the disclosure. As shown the figure, a first camera 202 and a second camera 204 are positioned at different angles to achieve a wider combined FOV. The first camera 202 captures a first portion of the scene, and the second camera 204 captures a second portion of the scene. As shown, the optical axis 206 of the first camera 202 and the optical axis 208 of the second camera 204 diverge from one another towards (e.g., en route to) the scene.

A first LED 502 and a second LED 504 are positioned to illuminate the scene while emitting light away from both cameras. Here, the first LED 502 illuminates the first portion of the scene, while an image of the first portion of the scene is captured by the first camera 202. The arrangement avoids or reduces an amount of light emitted from the first LED 502 and reflected back from the common cover glass 508 being directly or indirectly captured by the second camera 204, which is adjacent to the first LED 502. This is due to the illumination axis 506 of the first LED 502 being directed away from the second camera 204. The avoidance or reduction of such reflected light is achieved even though the second camera 204 is located in close proximity to the first LED 502. In this embodiment, the illumination axis 506 of the first LED 502 is substantially parallel to the optical axis 206 of the first camera 202.

A similar arrangement is provided with respect to the second camera 204 and the second LED 504. The second LED 504 illuminates the second portion of the scene, while an image of the second portion of the scene is captured by the second camera 204. The arrangement avoids or reduces an amount of light emitted from the second LED 504 and reflected back from the common cover glass 508 being directly or indirectly captured by the first camera 202, which is adjacent to the second LED 504. This is due to the illumination axis (not shown) of the second LED 504 being directed away from the first camera 202. The avoidance or reduction of such reflected light is achieved even though the first camera 202 is located in close proximity to the second LED 504. In this embodiment, the illumination axis (not shown) of the second LED 504 is substantially parallel to the optical axis 208 of the second camera 204.

Once again, the illumination axis of each of the two LEDs 502 and 504 is aligned with the optical axis of one of the cameras. This fills the FOV (in the far field) of each camera with light as long as the angular emission of each LED is greater than the FOV of the respective camera. Also, each LED is orientated to emit light predominantly away from the adjacent camera, which greatly reduces the possibility of light contamination occurring when LED light reflects/scatters off the cover glass directly into the camera.

A support structure 510 may be used for mounting the two cameras 202 and 204 and two LEDs 502 and 504 at the desired locations and in the desired orientations behind the cover glass 508. The support structure may also be used to secure the cover glass 508. Furthermore, the support structure may be used to mount one or more optional opaque baffles 512 and 514, which are described in later sections.

According to an embodiment, the illumination axis 506 of the first LED 502 is substantially parallel with the optical axis 206 of the first camera 202, and the illumination axis (not shown) of second LED 504 is substantially parallel with the optical axis 208 of the second camera 204. Unlike in FIG. 4, the illumination axis 506 of the first LED 502 and illumination axis (not shown) of second LED 504 cross each other in a direction towards the scene.

At least one opaque baffle may be employed to separate one or both of the first or second light sources from one or both of the first or second image sensors. Referring to FIG. 4, for example, a first opaque baffle 412 may be employed to block light emitting from the second LED 404 from reflecting off the cover glass 408 and reaching the first camera 202 or the second camera 204. Similarly, a second opaque baffle 414 may be employed to block light emitting from the first LED 402 from reflecting off the cover glass 408 and reaching the second camera 204 or the first camera 202. Referring to FIG. 5, a first opaque baffle 512 may be employed to block light emitting from LEDs 502 or 504 from reflecting off the cover glass 508 and reaching the second camera 204. Similarly, a second opaque baffle 514 may be employed to block light emitting from LEDs 502 or 504 from reflecting off the cover glass 508 and reaching the first camera 202.

While FIGS. 4 and 5 show a generally “linear” arrangement of the first LED, second LED, first camera, and second camera sequentially placed along a line (oriented toward different illumination and optical axes), other arrangements may be implemented. For example, a “stacked” arrangement of the first LED, second LED, first camera, and second camera may be employed.

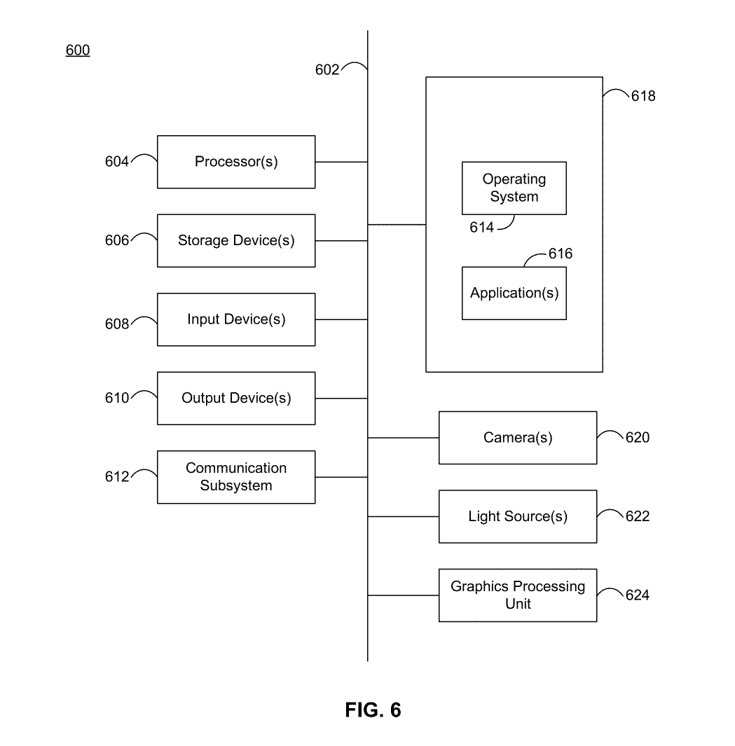

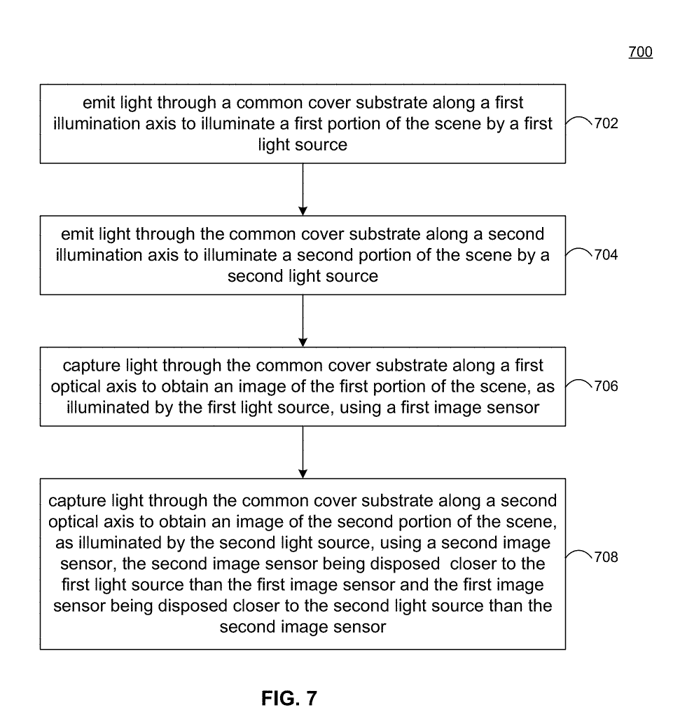

FIG. 6 is a system diagram of an illustrative system 600 employing the extended field-of-view illumination and imaging techniques of the present disclosure. System 600 may comprise processor(s) 604, storage device(s) 606, input device(s) 608, output device(s) 610, communication subsystem(s) 612, operating system 614, application(s) 616, working memory 618 in which data associated with operating system 614 and/or application(s) 616 may be stored, camera(s) 620 such at those described above with reference to FIGS. 4 and 5, light source(s) 622 such as LEDs described above with reference to FIGS. 4 and 5, and graphics processing unit 624. One example of system 600 can include a video-capable doorbell system or a security camera system. Processor(s) 604 may execute code stored on non-transitory computer readable medium and cause processor(s) 604 to carry out certain tasks, such as operating camera(s) 620 and light source(s) 622 in accordance with various embodiments of the disclosure, for example, FIG. 7. As such, system 600 can include the non-transitory computer readable medium that includes instructions that, when executed by one or more processing units (such as processor(s) 604) controlling system 600 comprising a common cover substrate, a first light source (such as light source(s) 622) having a first illumination axis, a second light source (such as light source(s) 622) having a second illumination axis, a first image sensor (such as camera(s) 620) having a first optical axis directed away from the second illumination axis, and a second image sensor (such as camera(s) 620) having a second optical axis directed away from the first illumination axis, wherein the second image sensor is disposed closer to the first light source than the first image sensor and the first image sensor is disposed closer to the second light source than the second image sensor, cause the one or more processing units to operate the first light source, the second light source, the first image sensor, and the second image sensor in accordance with the method described with reference to FIG. 7, below.

FIG. 7 is a flow chart presenting an example of a process 700 for extended field-of-view illumination and image capture of a scene. At step 702, light is emitted through a common cover substrate along a first illumination axis to illuminate a first portion of the scene by a first light source. Means for performing step 702 can, but not necessarily, include, for example, the first LED 402 shown in FIG. 4 or the first LED 502 shown in FIG. 5. At step 704, light is emitted through the common cover substrate along a second illumination axis to illuminate a second portion of the scene by a second light source. Means for performing step 704 can, but not necessarily, include, for example, the second LED 404 shown in FIG. 4 or the second LED 504 shown in FIG. 5. At step 706, light is captured through the common cover substrate along a first optical axis to obtain an image of the first portion of the scene, as illuminated by the first light source, using a first image sensor. Means for performing step 706 can, but not necessarily, include, for example, the first camera 202 shown in FIG. 4 or the first camera 202 shown in FIG. 5. At step 708, light is captured through the common cover substrate along a second optical axis to obtain an image of the second portion of the scene, as illuminated by the second light source, using a second image sensor, the second image sensor being disposed closer to the first light source than the first image sensor and the first image sensor being disposed closer to the second light source than the second image sensor. Means for performing step 708 can, but not necessarily, include, for example, the second camera 204 shown in FIG. 4 or the second camera 204 shown in FIG. 5. According to one embodiment, the first illumination axis of the first light source is directed away from the second optical axis of the second image sensor. Furthermore, the second illumination axis of the second light source may be directed away from the first optical axis of the first image sensor.

What is claimed is:

1. An apparatus for extended field-of-view illumination and image capture of a scene comprising:
a first light source oriented along a first illumination axis;
a second light source oriented along a second illumination axis;
a first image sensor oriented along a first optical axis;
a second image sensor oriented along a second optical axis;
wherein the first light source, second light source, first image sensor, and second image sensor are separated from the scene by a common cover substrate;
wherein the first light source is configured to illuminate a first portion of the scene, by emitting light through the common cover substrate, and the second light source is configured to illuminate a second portion of the scene, by emitting light through the common cover substrate;
wherein the first image sensor is configured to obtain an image of the first portion of the scene, as illuminated by the first light source, by capturing light through the common cover substrate, and the second image sensor is configured to obtain an image of the second portion of the scene, as illuminated by the second light source, by capturing light through the common cover substrate;
wherein the first illumination axis of the first light source is directed away from the second optical axis of the second image sensor, the second image sensor being closer to the first light source than the first image sensor; and
wherein the second illumination axis of the second light source is directed away from the first optical axis of the first image sensor, the first image sensor being closer to the second light source than the second image sensor.

2. The apparatus of claim 1, wherein the first optical axis is substantially parallel to the first illumination axis.

3. The apparatus of claim 1, wherein the second optical axis is substantially parallel to the second illumination axis.

4. The apparatus of claim 1, wherein the first and second optical axes cross each other in a direction towards the scene.

5. The apparatus of claim 4, wherein the first and second illumination axes diverge from each other in a direction towards the scene.

6. The apparatus of claim 1, wherein the first and second optical axes diverge from each other in a direction towards the scene.

7. The apparatus of claim 6, wherein the first and second illumination axes cross each other in a direction towards the scene.

8. The apparatus of claim 1, further comprising at least one opaque baffle separating one or both of the first or second light sources from one or both of the first or second image sensors.

9. The apparatus of claim 1, wherein the common cover substrate has a flat shape.

10. The apparatus of claim 1, wherein the common cover substrate has a curved shape.

11. The apparatus of claim 1, wherein the common cover substrate comprises a glass material.

12. The apparatus of claim 1, wherein the common cover substrate comprises a synthetic material.

13. A method for extended field-of-view illumination and image capture of a scene comprising:
emitting light through a common cover substrate along a first illumination axis to illuminate a first portion of the scene by a first light source;
emitting light through the common cover substrate along a second illumination axis to illuminate a second portion of the scene by a second light source;
capturing light through the common cover substrate along a first optical axis to obtain an image of the first portion of the scene, as illuminated by the first light source, using a first image sensor;
capturing light through the common cover substrate along a second optical axis to obtain an image of the second portion of the scene, as illuminated by the second light source, using a second image sensor, the second image sensor being disposed closer to the first light source than the first image sensor and the first image sensor being disposed closer to the second light source than the second image sensor;
wherein the first illumination axis of the first light source is directed away from the second optical axis of the second image sensor; and
wherein the second illumination axis of the second light source is directed away from the first optical axis of the first image sensor.

14. The method of claim 13, wherein the first optical axis is substantially parallel to the first illumination axis.

15. The method of claim 13, wherein the second optical axis is substantially parallel to the second illumination axis.

16. The method of claim 13, wherein the first and second optical axes cross each other in a direction towards the scene.

17. The method of claim 16, wherein the first and second illumination axes diverge from each other in a direction towards the scene.

18. The method of claim 13, wherein the first and second optical axes diverge from each other in a direction towards the scene.

19. The method of claim 18, wherein the first and second illumination axes cross each other in a direction towards the scene.

20. The method of claim 13, wherein:
at least one opaque baffle separates one or both of the first or second light sources from one or both of the first or second image sensors.

21. A system for extended field-of-view illumination and image capture of a scene comprising:
means for emitting light through a common cover substrate along a first illumination axis to illuminate a first portion of the scene by a first light source;
means for emitting light through the common cover substrate along a second illumination axis to illuminate a second portion of the scene by a second light source;
means for capturing light through the common cover substrate along a first optical axis to obtain an image of the first portion of the scene, as illuminated by the first light source, using a first image sensor;
means for capturing light through the common cover substrate along a second optical axis to obtain an image of the second portion of the scene, as illuminated by the second light source, using a second image sensor, the second image sensor being disposed closer to the first light source than the first image sensor and the first image sensor being disposed closer to the second light source than the second image sensor;
wherein the first illumination axis of the first light source is directed away from the second optical axis of the second image sensor; and
wherein the second illumination axis of the second light source is directed away from the first optical axis of the first image sensor.

22. The system of claim 21, wherein the first optical axis is substantially parallel to the first illumination axis.

23. The system of claim 21, wherein the second optical axis is substantially parallel to the second illumination axis.

24. The system of claim 21, wherein the first and second optical axes cross each other in a direction towards the scene.

25. The system of claim 24, wherein the first and second illumination axes diverge from each other in a direction towards the scene.

26. The system of claim 21, wherein the first and second optical axes diverge from each other in a direction towards the scene.

27. The system of claim 26, wherein the first and second illumination axes cross each other in a direction towards the scene.

28. A non-transitory computer-readable medium having instructions embedded thereon for providing extended field-of-view illumination, the instructions, when executed by one or more processing units controlling an apparatus comprising a common cover substrate, a first light source having a first illumination axis, a second light source having a second illumination axis, a first image sensor having a first optical axis directed away from the second illumination axis, and a second image sensor having a second optical axis directed away from the first illumination axis, wherein the second image sensor is disposed closer to the first light source than the first image sensor and the first image sensor is disposed closer to the second light source than the second image sensor, cause the one or more processing units to:
operate the first light source to illuminate a first portion of a scene by emitting light through the common cover substrate along the first illumination axis;
operate the second light source to illuminate a second portion of the scene by emitting light through the common cover substrate along the second illumination axis;
operate the first image sensor oriented along the first optical axis to capture light through the common cover substrate to obtain an image of the first portion of the scene;
operate the second image sensor oriented along the second optical axis to capture light through the common cover substrate to obtain an image of the second portion of the scene.
